(19) United States
(12) Patent Application Publication
(10) Pub. No.: US 2011/0095839 A1
(43) Pub. Date: Apr. 28, 2011

(54) PREVENTION STRUCTURE TO PREVENT SIGNAL LINES FROM TIME-SKEW

(75) Inventor: Cheng-Hui CHU, TAIPEI CITY (TW)

(73) Assignee: INVENTEC CORPORATION, TAIPEI CITY (TW)

(21) Appl. No.: 12/648,286

(22) Filed: Dec. 28, 2009

(30) Foreign Application Priority Data
Oct. 22, 2009 (TW) 98135809

(51) Int. Cl. H01P 3/08

(52) U.S. Cl. 333/4; 333/238

(57) ABSTRACT

A prevention structure to prevent signal lines from time-skew is described. The prevention structure includes a plurality pairs of differential signal lines and a prevention line. The adjacent pairs of differential signal lines are separated from each other by a first gap. Each pair of the differential signal lines includes a positive signal line and a negative signal line each having a first line width. The prevention line has the second line width substantially equal to the first line width and is separated from the outmost differential signal line by a second distance substantially equal to the first distance.

### RELATED APPLICATIONS

This application claims priority to Taiwan Application Serial Number 98135809, filed Oct. 22, 2009, which is herein incorporated by reference.

### FIELD OF THE INVENTION

The present disclosure relates to a signal line structure, and more particularly to a prevention structure to prevent signal lines from time-skew.

### BACKGROUND OF THE INVENTION

With the need of increasing transmission speed of the signal and increasing length of the transmission distance of the modern communication, differential signal lines are widely used to overcome the deficiencies of the transmission distance and the strength of single signal line and to keep the greater completeness of the signal while parallelizedly transmitting data by a flat cable. The differential signal lines transmit data with paired complementary signals. The advantages of the differential signal lines are that the paired complementary signals have a larger tolerance for the external interference to decrease crosstalk, feedback and noise.

However, except for the mutual effects between a pair of differential signal lines, the geometric shape in the peripheral of each pair of differential signal lines has become very important. If no appropriate design is provided, the capacitance or the inductance between the differential signal lines is easily affected changing the transmission speed of the signal. Specifically speaking, these high-speed differential signal lines are usually collectively wound as a group. But, the outmost differential signal line is different from the other inner differential signal lines that have differential signal lines set on both sides. Therefore, the differential signal lines at the edges are the easiest ones to be affected resulting in different signal transmission speed and, in turn, causing time-skew. In the prior art, in order to prevent the differential signal line at the marginal region from being affected by the external environments, a ground wire is often disposed outside the differential signal line at the marginal region, and the size of the ground wire is the wider the better in order to resist the external noise. However, such method cannot solve the defects of signal error caused by time-skew.

Therefore, it is an issue to solve in the industry that how to design a new prevention structure to protect the differential signal line at the marginal region to prevent time-skew.

### SUMMARY OF THE INVENTION

Therefore, one aspect of the present disclosure is to provide a prevention structure to prevent signal lines from time-skew, including a plurality pairs of differential signal lines and a prevention line. Any two adjacent pairs of the plurality pairs of differential signal lines are separated from each other by a first gap, and each pair of the differential signal lines includes a positive signal line and a negative signal line each having a first line width. The prevention line has a second line width substantially equal to the first line width and is separated from an outmost differential signal line of the differential signal lines by a second gap substantially equal to the first gap.

According to a preferred embodiment of the present disclosure, the prevention line is a ground wire.

According to another preferred embodiment of the present disclosure, the differential signal lines and the prevention line are formed on a printed circuit board or an integrated circuit.

According to further another preferred embodiment of the present disclosure, a material of the differential signal lines is copper.

According to still another preferred embodiment of the present disclosure, a material of the prevention line is copper.

According to yet another preferred embodiment of the present disclosure, each of the differential signal lines is a strip line.

According to still further another preferred embodiment of the present disclosure, each of the differential signal lines is a micro strip line.

The advantages of applying the present disclosure are that the geometric shape of the marginal portion of the differential signal lines can be symmetrical by providing a prevention structure with a specific line width and a specific gap, such that the effect of the peripheral shape on the speed of the signal transmitted in the differential signal line at the marginal portion can be decreased at most, thereby greatly reducing the probability of time-skew to easily achieve the aforementioned objectives.

### BRIEF DESCRIPTION OF THE DRAWINGS

The foregoing and other objects, features, advantages and embodiments of this disclosure are more readily appreciated as the same become better understood by reference to the following detailed description, when taken in conjunction with the accompanying drawings, wherein:

FIG. 1 illustrates a vertical view of a printed circuit board in accordance with an embodiment of the present disclosure; and

FIG. 2 illustrates a cross-sectional view of two pairs of differential signal lines and a prevention line taken along a cross-sectional line A-A of FIG. 1.

### DETAILED DESCRIPTION OF THE PREFERRED EMBODIMENT

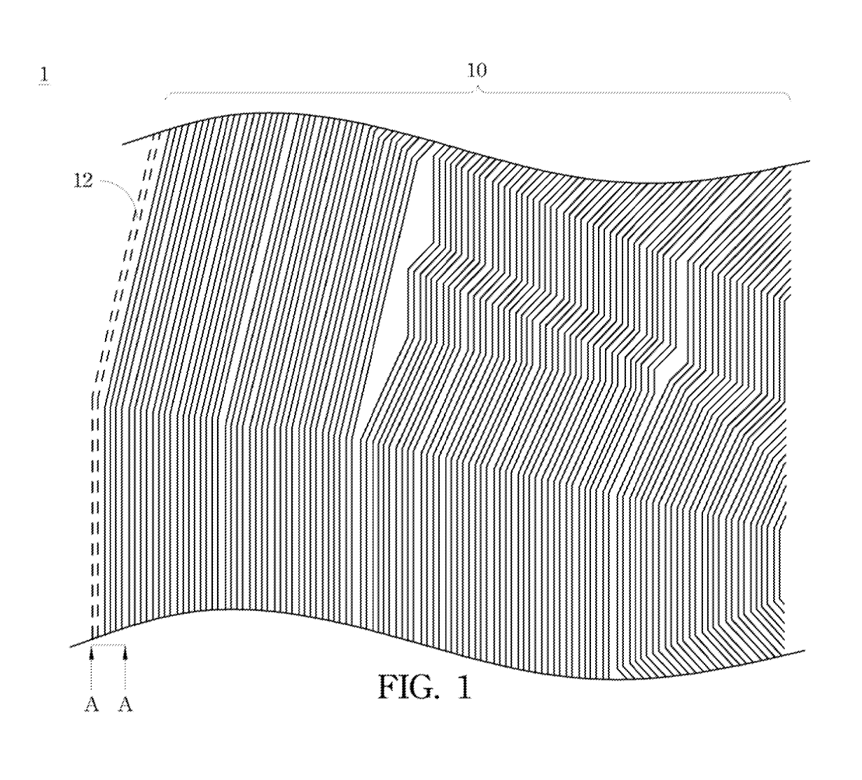

Refer to FIG. 1. FIG. 1 illustrates a vertical view of a printed circuit board 1 in accordance with an embodiment of the present disclosure. In order to make the illustration of the present invention more explicit, FIG. 1 only illustrates a part of the printed circuit board 1. The printed circuit board 1 includes a prevention structure to prevent signal lines from time-skew, which includes a plurality pairs of differential signal lines 10 and a prevention line 12. The prevention line 12 is illustrated by a dotted line. The differential signal lines 10 are collectively wound as a group.

In the present embodiment, the differential signal lines 10 are formed on the printed circuit board 1. In other embodiments, the differential signal lines 10 may be formed on an integrated circuit chip. The differential signal lines 10 formed on a surface of the circuit board or a surface of the integrated circuit are referred to micro strip lines, and the differential signal lines 10 formed in the inner of the circuit board or the inner of the integrated circuit are referred to strip lines. The differential signal lines 10 may be made of copper for the benefit of high-speed transmission of signal. In the present disclosure, the locations of the differential signal lines 10 are not limited, and the differential signal lines 10 have different arrangements in different embodiments.

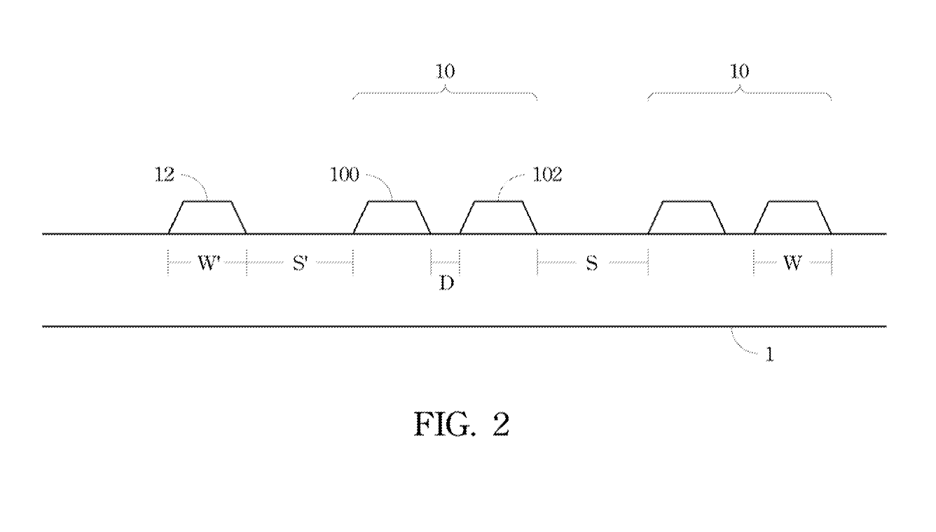

Simultaneously refer to FIG. 2. FIG. 2 illustrates a cross-sectional view of two pairs of differential signal lines 10 and a prevention line 12 taken along a cross-sectional line A-A of FIG. 1. The adjacent pairs of the differential signal lines are separated from each other by a first gap S. Each pair of the differential signal lines 10 includes a positive signal line 100 and a negative signal line 102. The signals are complementary, which are respectively transmitted by the positive signal line 100 and the negative signal line 102. With such design, it can prevent the crosstalk, feedback and noise from occurring. Each of the positive signal line, 100 and the negative signal line 102 has a first line width W. A positive-negative signal line gap D is substantially between the positive signal line 100 and the negative signal line 102 of each pair of differential signal lines 10.

It should be noted that the positive signal line 100 shown in FIG. 2 is at the outer side, and the negative signal line 102 is at the inner side. However, in other embodiments, the positive signal line 100 may be disposed at the inner side, and the negative signal line 102 may be disposed at the outer side, so that the arrangement of the positive signal line 100 and the negative signal line 102 is not limited to the embodiment illustrated in FIG. 2.

Because there are other differential signal lines 10 disposed in the peripheral of the inner differential signal line 10, the geometric shape in the peripheral of the inner differential signal line 10 is symmetrical. Only one side of the outmost differential signal line 10 has a differential signal line 10 nearby, and the geometric shape in the peripheral of the outmost differential signal line 10 is asymmetric. In such arrangement, the signal transmitted in the outmost differential signal line 10 is easily affected, so that a time-skew phenomenon occurs between the signal and other signals.

The symmetrical geometric shape in the peripheral of the outmost differential signal line 10 can be achieved by providing the prevention line 12. The prevention line 12 has the second line width W′ substantially equal to the first line width W. In addition, a second gap S′ exists between the prevention line 12 and the outmost differential signal line 10, and the second gap S′ is substantially equal to the first gap S. The term “substantially” described above is referred to the situation that the difference between the second line width W′ and the first line width W is between positive 5 percent and negative 5 percent of the first line width W, or the difference between the second gap S′ and the first gap S is between positive 5 percent and negative 5 percent of the first gap S. With such arrangement, the geometric shape in the peripheral of the outmost differential signal line 10 is symmetrical. If the prevention line 12 is designed to have a larger width as described in the prior art, only the larger line width of the prevention line 12 can be used to isolate the external noise to be applied on the outmost differential signal line 10. But, the geometric shape in the peripheral of the outmost differential signal line 10 is still asymmetric, such that the speed of the signal transmitted by the outmost differential signal line 10 is different from the speed of the signal transmitted by the inner differential signal lines 10. However, when the prevention line 12 is designed to have a second line width W′, which is equal to the first line width W, and a second gap S′, which is equal to the first gap S, the geometric shape in the peripheral of the outmost differential signal line 10 is symmetrical. Therefore, the speed of the signal transmitted by the outmost differential signal line 10 is equal to the speed of the signal transmitted by the inner differential signal lines 10.

In one embodiment, the prevention line 12 is a ground wire and does not need to transmit any signal. In different embodiments, the prevention line 12 may be made of copper or other metals.

The following Table 1 shows the simulation results of the relationships between the widths of the prevention lines 12 and the corresponding time-skew amounts when the differential signal lines 10 are micro strip lines.

TABLE 1

| Second Width W′ | Time-skew Amount | Improvement Rate |
|---|---|---|
| (mil) | (ps) | (%) |
| N/A | 11.693 | — |
| 4 | 9.504 | 18.72 |
| 6 | 8.611 | 26.36 |
| 10 | 9.162 | 21.65 |
| 18 | 8.626 | 26.23 |

Table 1 shows the simulation results of the time-skew amounts and the improvement rates on the conditions including no prevention line 12 (N/A) and the widths of the prevention line 12 are 4 mils, 6 mils, 10 mils and 18 mils respectively, when the voltage of the input signal is 1 V, the first width W is 6 mils (a thousandth of one inch), the gap D between the positive signal line 100 and the negative signal line 102 of each pair of the differential signal lines 10 is 6 mils, each of the first gap S and the second gap S′ is 17.5 mils, the length of each pair of the differential signal lines 10 is 19 inches. The prevention line 12 is a ground wire.

Therefore, according to Table 1, it is known that when the second width W′ is equal to the first width W, it has the smallest time-skew amount, which is equal to 8.611 ps, and the largest improvement rate (26.36%) in comparison with the condition of no prevention line 12 (N/A). In the largest line width (18 mils) condition, the improvement rate is 26.23%, which is less than the improvement rate when the second width W′ is equal to the first width W.

The following Table 2 shows the simulation results of the relationships between the widths of the prevention lines 12 and the corresponding time-skew amounts when the differential signal lines 10 are strip lines.

TABLE 2

| Second Width W′ | Time-skew Amount | Improvement Rate |
|---|---|---|
| (mil) | (ps) | (%) |
| N/A | 1.215 | — |
| 3 | 0.491 | 59.59 |
| 5 | 0.279 | 77.04 |
| 10 | 1.354 | −11.44 |
| 16 | 0.850 | 30.04 |

Table 2 shows the simulation results of the time-skew amounts and the improvement rates on the conditions including no prevention line 12 (N/A) and the widths of the prevention line 12 are 3 mils, 5 mils, 10 mils and 16 mils respectively, when the voltage of the input signal is 1 V, the first width W is 5 mils (a thousandth of one inch), the gap D between the positive signal line 100 and the negative signal line 102 of each pair of the differential signal lines 10 is 6 mils, each of the first gap S and the second gap S′ is 17.5 mils, the length of each pair of the differential signal lines 10 is 19 inches. The prevention line 12 is a ground wire.

Therefore, according to Table 2, it is known that when the second width W′ is equal to the first width W, it has the smallest time-skew amount (0.279 ps) and the largest improvement rate (77.04%) in comparison with the condition of no prevention line 12 (N/A). In the largest line width (16 mils) condition, the improvement rate is only 30.04%.

In the prevention structure to prevent signal lines from time-skew of the present disclosure, the geometric shape of the marginal portion of the differential signal lines can be symmetrical by providing a prevention structure with a specific line width and a specific gap, such that the effects of the peripheral shape on the speed of the signal transmitted in the differential signal line in the marginal portion can be controlled to the weakest, thereby greatly reducing the probability of time-skew.

As is understood by a person skilled in the art, the foregoing embodiments of the present disclosure are illustrative of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A prevention structure to prevent signal lines from time-skew, including:
a plurality pairs of differential signal lines, wherein any two adjacent pairs of the plurality pairs of differential signal lines are separated from each other by a first gap, and each pair of the differential signal lines includes a positive signal line and a negative signal line each having a first line width; and
a prevention line having a second line width substantially equal to the first line width and being separated from an outmost differential signal line of the differential signal lines by a second gap substantially equal to the first gap.

2. The prevention structure to prevent signal lines from time-skew according to claim 1, wherein the prevention line is a ground wire.

3. The prevention structure to prevent signal lines from time-skew according to claim 1, wherein the differential signal lines and the prevention line are formed on a printed circuit board.

4. The prevention structure to prevent signal lines from time-skew according to claim 1, wherein the differential signal lines and the prevention line are formed on an integrated circuit.

5. The prevention structure to prevent signal lines from time-skew according to claim 1, wherein a material of the differential signal lines is copper.

6. The prevention structure to prevent signal lines from time-skew according to claim 1, wherein a material of the prevention line is copper.

7. The prevention structure to prevent signal lines from time-skew according to claim 1, wherein each of the differential signal lines is a strip line.

8. The prevention structure to prevent signal lines from time-skew according to claim 1, wherein each of the differential signal lines is a micro strip line.
